(19) United States
(12) Patent Application Publication
(10) Pub. No.: US 2020/0256415 A1
(43) Pub. Date: Aug. 13, 2020

(54) COIL SPRING

(71) Applicant: AMPD ENERGY LIMITED, Hong Kong (CN)

(72) Inventors: Kevin CHAN, Hong Kong (CN); Luciano Gurgel VALENTE, Hong Kong (CN); Brandon Boon Soon NG, Hong Kong (CN); Wai Kee Ricky CHENG, Hong Kong (CN)

(21) Appl. No.: 15/776,076

(22) PCT Filed: Nov. 16, 2016
(86) PCT No.: PCT/CN2016/106002

§ 371 Date: May 15, 2018

Related U.S. Application Data
(60) Provisional application No. 62/256,679, filed on Nov. 17, 2015.

(51) Int. Cl. F16F 1/08; H01M 2/10; H01M 2/20; H01R 13/24

(52) U.S. Cl. CPC F16F 1/08; H01M 2/1022; H01M 2220/30; H01R 13/2421; H01M 2/20

(57) ABSTRACT

A coil spring (100) includes a top portion (110) and a bottom portion (120). The top portion (110) includes three coils that are vertically stacked on top of each other to have a straight cylindrical shape in a side-view of the top portion (110). The three coils connect together such that no gap exists between the three coils in the side-view. The top portion (110) includes a top coil (115) that extends one and one-half turns along a flat plane as seen from a top-view of the top portion (110). The bottom portion (120) includes multiple coils that form a truncated-cone shape in the side-view and that in a compressed state extends one and one-half turns along a flat plane as seen from a bottom-view of the bottom portion (120).

### FIELD OF THE INVENTION

The present invention relates to springs, and in particular electrically conductive coil springs.

### BACKGROUND ART

Electronic devices often require portable power from batteries. The batteries are arranged in parallel or in series in an assembly or pack to obtain a desired capacity or voltage. Springs, as battery contacts, electrically connect to the battery terminals so that failed or damaged battery cells of the battery pack can be replaced with new battery cells.

In view of the demand for portable power, improvements in battery contacts are desired.

### SUMMARY OF THE INVENTION

One example embodiment is a coil spring that includes a top portion and a bottom portion. The top portion includes three coils that are vertically stacked on top of each other to have a straight cylindrical shape in a side-view of the top portion. The three coils connect together such that no gap exists between the three coils in the side-view. The top portion includes a top coil that extends one and one-half turns along a flat plane as seen from a top-view of the top portion. The bottom portion includes multiple coils that form a truncated-cone shape in the side-view and that in a compressed state extends one and one-half turns along a flat plane as seen from a bottom-view of the bottom portion.

Other example embodiments are discussed herein.

### BRIEF DESCRIPTION OF THE DRAWINGS

FIG. 1A shows a coil spring in an uncompressed state from a side-view in accordance with an example embodiment.

FIG. 1B shows a coil spring in an uncompressed state from a top-view in accordance with an example embodiment.

FIG. 2A shows a coil spring in a collapsed state from a side-view in accordance with an example embodiment.

FIG. 2B shows a coil spring in a collapsed state from a top-view in accordance with an example embodiment.

FIG. 3A shows a cross sectional view of a bottom portion of a coil spring in an uncompressed state in accordance with an example embodiment.

FIG. 3B shows a cross sectional view of a bottom portion of a coil spring in a collapsed state in accordance with an example embodiment.

FIG. 4 shows a top coil of a coil spring from a top-view in accordance with an example embodiment.

FIG. 5 shows a side-view of two coil springs connected with batteries in accordance with an example embodiment.

### DETAILED DESCRIPTION OF EMBODIMENTS

A battery contact spring (such as a coil spring) provides pressure to hold batteries in place as well as to conduct electrical current from the batteries to a desired circuit or electronic component. Battery contact springs with low resistance and long lifetime are desired.

Example embodiments relate to coil springs or conical compression springs that connect to batteries as battery contacts. The coil spring contacts the battery to hold the battery in place as well as to conduct electric current from the battery to a desired circuit, terminal, or electrical component. The coil spring is desired to have a large contact area with the battery in order to minimize the contact resistance.

An example embodiment includes a coil spring with a top portion and a bottom portion. The top portion includes at least two coils that are vertically stacked on top of each other to have a straight cylindrical shape in a side-view of the top portion. A top coil in the top portion extends one and one-half turns along a flat plane as seen from a top-view of the top portion. The bottom portion includes multiple coils that form a truncated-cone shape in the side-view. The bottom portion, in a compressed state, extends one and one-half turns along a flat plane as seen from a bottom-view of the bottom portion.

In one embodiment for example, the coils in the top portion are vertically stacked such that no gap exists between the coils in the side-view. A circumference of a bottom surface of one coil engages a circumference of a top surface of another coil. The coils are in contact to each other such that the height of the top portion remains unchanged with the coil spring is fully compressed versus when the spring is fully uncompressed.

In one embodiment for example, the top portion of the coil spring has a top coil that contacts the battery and includes three coils. The top coil of these three coils extends one and one-half turns to form in a spiral shape in which an entirety of the one and one-half turns resides in a flat plane.

In an example embodiment, the coil spring is made by winding a conductive wire. The diameter of the conductive wire is one millimeter (mm) from a cross-sectional view of the conductive wire. The height of the coil spring in an uncompressed state is at least 5.0 mm in which the top portion is at least 2.0 mm. For example, the height of the coil spring in an uncompressed state is between 6.5 mm-7.0 mm (e.g., 6.7 mm). The top portion is 2.8 mm-3.2 mm (e.g., 3 mm) high, and the bottom portion is 3.5 mm-4.0 mm (e.g., 3.7 mm) high. The height of the coil spring reduces, for example, by about 1.8 mm-2.2 mm. For example, when the coil spring has a height of 6.7 mm in an uncompressed state, the coil spring reduces to 4.7 mm in a compressed state with a total reduction in height of 2.0 mm when measured from a side-view.

In an example embodiment, the coil spring compresses and pushes against a battery to electrically connect the battery with a base carrier and hold the battery in place. The coil spring is sandwiched between the battery and the base carrier and is compressed to a collapsed state, in which the top portion of the coil spring collapses inside the bottom portion and contacts the base carrier. In this configuration, the electrical path from the battery to the base carrier through the coil spring is shortened. The effective resistance of the coil spring, which is the path resistance from the battery to the base carrier through the coil spring, is decreased.

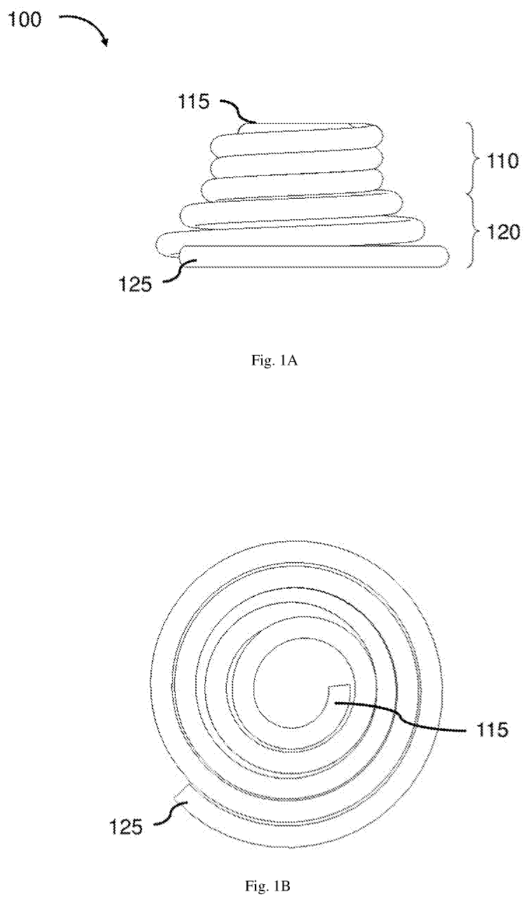

FIG. 1A shows a coil spring 100 in an uncompressed state from a side-view in accordance with an example embodiment.

FIG. 1B shows the coil spring 100 as shown in FIG. 1A from a top-view in accordance with an example embodiment.

The coil spring or conical compression spring 100 includes a top portion 110 and a bottom portion 120. The top portion 110 includes three coils and a top coil 115. The three coils are vertically stacked on top of each other and such that each of the three coils has a same or similar circular diameter. The bottom portion 120 includes multiple coils that form a truncated-cone shape in the side-view. A bottom coil or base coil 125 in the bottom portion functions as a base for the coil spring.

By way of example, the top portion is inelastic and has a straight cylindrical shape in a side-view of the top portion. The top portion has three concentric coils forming three circles with equal diameters. The three coils are vertically stacked and connected together such that no gap exists between the coils in the side-view. A circumference of a bottom surface of one coil engages a circumference of a top surface of another coil. In this configuration, a height of the top portion remains unchanged when the coil spring is fully compressed versus when the coil spring is fully uncompressed. This configuration of stacked coils shortens the electrical and thermal conduction path from the top coil to the base coil through the coil spring. For example, the electrical resistance of the coil spring is 8.04 milliohm when coils in the top portion are not in contact with each other. The resistance reduces from 8.04 milliohm to 7.40 milliohm when the coils in the top portion contact each other.

In one embodiment for example, the top portion 120 of the coil spring includes a top coil 115 that contacts the battery. The top coil extends more than one turn in a spiral shape in which an entirety of the more than one turn resides in a horizontal plane as seen from a top-view of the top portion as shown in FIG. 1B. The horizontal plane is a plane that is vertical to the central axis of the coil spring. As one example, the top coil winds around a center point in the horizontal plane at a decreasing distance from the center point to form an arc of at least 360 degrees, for example, 540 degrees.

In an example embodiment, the bottom portion has a truncated-cone shape and a diameter larger than the top portion. The bottom portion is elastic and contributes to the motive force of the coil spring. The bottom portion has less than two turns, in which the bottom coil in the bottom portion extends less than one turn along a flat plane and functions as a base of the coil spring.

In an example embodiment, the coil spring is made by winding a conductive wire. The diameter of the conductive wire is one millimeter (mm) from a cross-sectional view of the conductive wire. The height of the coil spring in an uncompressed state is 6.0 mm to 7 mm. In an example embodiment, the height of the coil spring is 6.7 mm in which the top portion is 3 mm high and the bottom portion is 3.7 mm high. In another example, the height of the top portion is 2.8 mm-3.2 mm (hereinafter about 3 mm) and the height of the bottom portion is 3.5 mm-3.9 mm (hereinafter about 3.7 mm).

In one example embodiment, the top portion of the coil spring is mounted into a carrying cap, allowing the coil spring to be picked and positioned by industry standard SMT component placement systems or “pick-and-place machines” to automate and robotize the coil springs onto a base carrier.

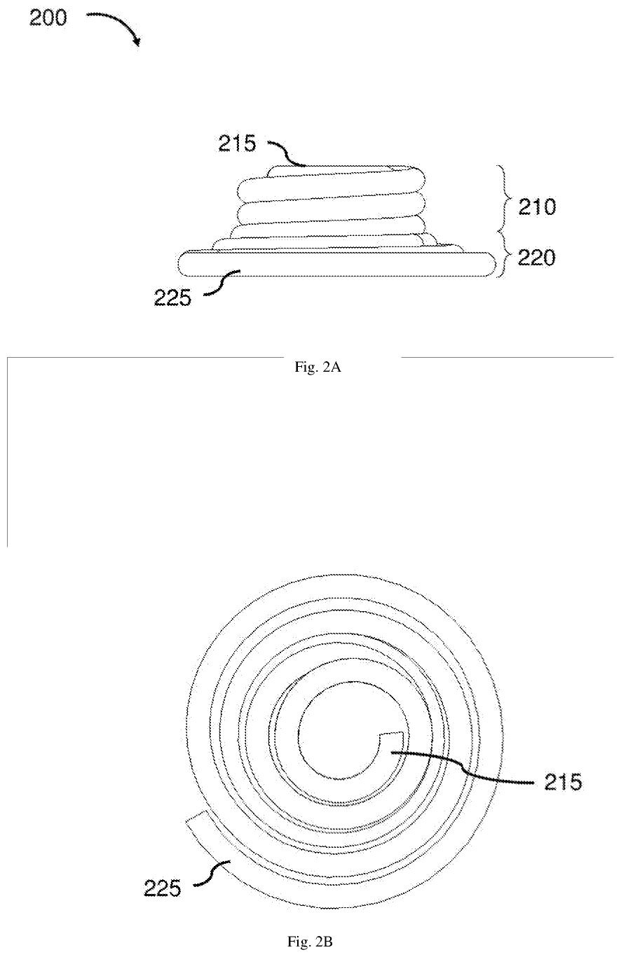

FIG. 2A shows a coil spring 200 in a collapsed state from a side-view in accordance with an example embodiment.

FIG. 2B shows the coil spring 200 as shown in FIG. 2A from a top-view in accordance with an example embodiment.

The coil spring or conical compression spring 200 includes a top portion 210 and a bottom portion 220. The top portion 210 includes three coils that are vertically stacked on top of each other and a top coil 215. The bottom portion 220 includes multiple coils that are enclosed in a bottom coil or base coil 225.

By way of example, the top portion is inelastic and has a straight cylindrical shape in a side-view of the top portion. As such, a height of the top portion does not change or remains constant when the coil spring transitions between the compressed state and uncompressed state. The top portion has at least two concentric coils forming two circles with equal diameters in which the two coils are vertically stacked and connected together such that no gap exists between the coils in the side-view. A circumference of a bottom surface of one coil engages a circumference of a top surface of another coil. In the collapsed state, the top portion collapses inside the bottom portion.

In one embodiment for example, the top portion 220 of the coil spring includes a top coil 215 that contacts the battery. The top coil extends more than one turn in a spiral shape in which an entirety of the more than one turn resides in a flat plane as seen from a top-view of the top portion as shown in FIG. 2B. The flat plane is vertical to the central axis of the coil spring. As one example, the top coil winds along the flat plane for at least 360 degrees, for example, 500 degrees.

In an example embodiment, the bottom portion has less than two turns in total and the bottom coil extends less than one turn along a surface on a base carrier. The bottom coil is soldered to the base carrier and functions as the base of the coil spring. The bottom portion has a diameter larger than the top portion such that the top portion collapses inside the bottom portion to contact the base carrier when the coil spring is compressed to a collapsed state. In this configuration, the contact area between the coil spring and the base carrier is larger in the collapsed state than in the uncompressed state.

Consider an example embodiment in which a plurality of battery cells are positioned in a side-by-side relationship such that each of the batteries is in electrical contact with a base carrier via a coil spring at a first terminal end and with a top cover at a second terminal end. The bottom coil of the coil spring is soldered to the base carrier to stabilize the coil spring. The top coil of the coil spring is in contact with the first terminal end of one of the battery cells. The upper part of the bottom portion of the coil spring, which extends from the bottom coil, is an elastic half-turn coil. The elastic half-turn coil does not contact the base carrier when the coil spring is in the uncompressed state, and contacts the base carrier when the coil spring is compressed to the collapsed state. The elastic half-turn coil, which has an flexible height, ensures an even connection across the battery cells, as battery cells may each have minor differences in height due to manufacturing tolerances.

In an example embodiment, the coil spring has a height in an uncompressed state as seen from the side-view that is at least 5.0 mm, and the height decreases, for example, by at least 1.8 mm in a compressed state.

By way of example, the height of the coil spring in an uncompressed state is 6.0 mm to 7 mm. In an example embodiment, the height of the coil spring is 6.7 mm in which the top portion is 3 mm high and the bottom portion is 3.7 mm high. The height of the bottom portion decreases to 1.7 mm when the coil spring is compressed to the collapsed state. In another example, the height of the top portion is 2.8 mm-3.2 mm (hereinafter about 3 mm). The height of the bottom portion is 3.5 mm-3.9 mm (hereinafter about 3.7 mm). The height of the bottom portion decreased to 1.5 mm-1.9 mm (hereinafter about 1.7 mm) when the coil spring is compressed to the collapsed state. As one example, the height of the bottom portion as seen from the side-view reduces by 2.0 mm from an uncompressed state to the compressed state.

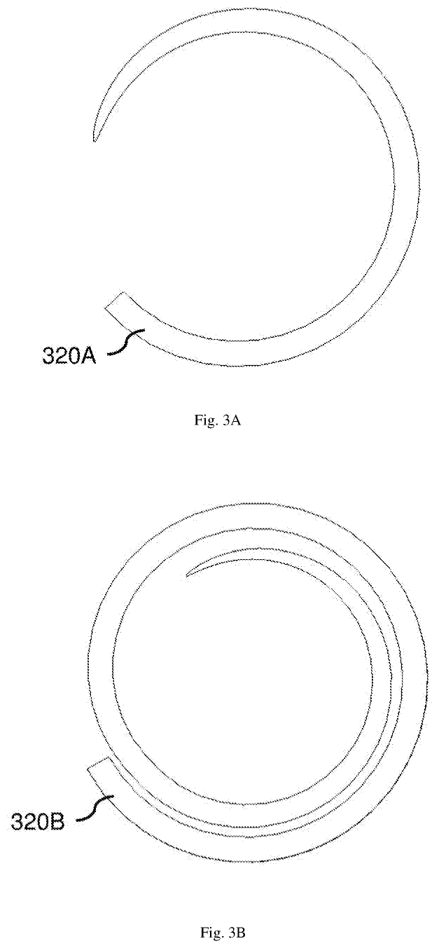

FIG. 3A shows a cross sectional view 320A of a bottom portion of a coil spring in an uncompressed state in accordance with an example embodiment.

FIG. 3B shows a cross sectional view 320B of a bottom portion of a coil spring in a collapsed state in accordance with an example embodiment.

Consider an example embodiment in which a coil spring is disposed on a base carrier. The bottom portion of the coil spring has more than one turn and less than two turns. The upper part of the bottom portion does not contact the base carrier when the coil spring is in an uncompressed state. A cross sectional view 320A of the bottom portion of an uncompressed coil spring long the base carrier is shown in FIG. 3A, which is less than one turn. The less than one turn is the lower part of the bottom portion which contacts the base carrier no matter the coil spring is in an uncompressed state or a collapsed state.

When the coil spring is compressed to the collapsed state, the height of the bottom portion of the coil spring decreases such that the upper part of the bottom portion contacts the base carrier. For example, the height of the bottom portion decreases from about 3.7 mm to about 1.7 mm. A cross sectional view 320B of the bottom portion of a collapsed coil spring along the base carrier is shown in FIG. 3B. In the collapsed state, the bottom portion, which is more than one turn and less than two turns, collapses onto the base carrier. The bottom portion of the coil spring has a flexible height and allows an even connection across the battery cells.

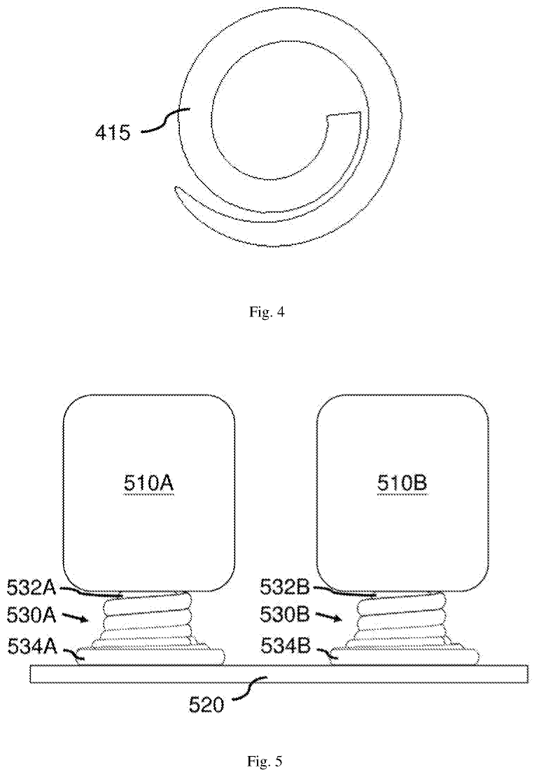

FIG. 4 shows a top coil 415 of a coil spring from a top-view in accordance with an example embodiment. The top coil 415 extends one and one-half turns along a flat plane as seen from a top-view of the top portion.

In one embodiment for example, the top coil contacts a battery terminal. The top coil extends more than one turn to form in a spiral shape in which an entirety of the more than one turn resides in a flat plane and contacts the battery terminal. As one example, the top coil winds around a center point in the horizontal plane at a decreasing distance from the center point to form an arc of at least 360 degrees, for example, 540 degrees. This configuration of the top coil maximizes the contact area between the coil spring and the battery terminal such that the contact resistance is decreased.

FIG. 5 shows a side-view of two coil springs 530A and 530B connected with batteries 510A and 510B, respectively. The coil springs are positioned between the batteries and a base carrier 520. Each coil spring includes a top coil (shown as 532A and 532B) and a bottom coil or a base coil (shown as 534A and 534B). The top coil contacts the battery and the bottom coil contacts the base carrier.

By way of example, the coil spring compresses and pushes against the battery to electrically connect the battery with the base carrier and hold the battery in place. The coil spring is sandwiched between the battery and the base carrier and is compressed to a collapsed state, in which the top portion of the coil spring collapses inside the bottom portion and contacts the base carrier. In this configuration, the electrical path from the battery to the base carrier through the coil spring is shortened. The effective resistance of the coil spring, which is the path resistance from the battery to the base carrier through the coil spring, is decreased. For example, the effective resistance of the coil spring decreases by at least 8 percent when the coil spring is compressed from an uncompressed state, in which the coil spring is not compressed and has a free height, to a collapsed state, in which the top portion of the coil spring collapses inside the bottom portion and contacts the base carrier.

In one example embodiment, the contact area between the coil spring and the base carrier is larger in the collapsed state compared with the uncompressed state. In the collapsed state, the top portion of the coil spring collapses inside the bottom portion and contacts the base carrier. The larger contact area leads to a smaller contact resistance between the coil spring and the base carrier.

Consider an example embodiment in which a plurality of batteries are positioned in a side-by-side relationship in a battery assembly such that each of the batteries is in electrical contact with a base carrier via the coil spring at a first terminal end and with a top cover at a second terminal end. In this configuration, the coil springs compress and assist in supporting the batteries in the battery assembly and providing electrical contact between the batteries and the base carrier.

As used herein, a “battery assembly” is an assembly of two or more batteries or batteries cells that are configured in series, parallel, or a mixture of both to deliver a desired voltage, capacity, or power density.

As used herein, a “path resistance” is the resistance of a path from the beginning of the path to the end of the path.

As used herein, an “effective resistance” of the coil spring is an electrical path resistance through the coil spring.

As used herein, a “free height” is a height of an object when no external force is applied to the object.

What is claimed is:

1. A coil spring, comprising:
a top portion with three coils that are vertically stacked on top of each other to have a straight cylindrical shape in a side-view of the top portion, connect together such that no gap exists between the three coils in the side-view, include a top coil that extends one and one-half turns along a flat plane as seen from a top-view of the top portion; and
a bottom portion with multiple coils that form a truncated-cone shape in the side-view and that in a compressed state extends one and one-half turns along a flat plane as seen from a bottom-view of the bottom portion.

2. The coil spring of claim 1, wherein the coil spring has a height in an uncompressed state as seen from the side-view that is from 6.0 millimeters (mm) to 7.0 mm, and the height decreases by 1.8 mm to 2.2 mm in the compressed state.

3. The coil spring of claim 1, wherein a height of the bottom portion as seen from the side-view reduces by 2.0 millimeters from an uncompressed state to the compressed state.

4. The coil spring of claim 1, wherein a height of the top portion as seen from the side-view is about 3.0 millimeters (mm), and a height of the bottom portion as seen from the side-view is about 3.7 mm in an uncompressed state.

5. The coil spring of claim 1, wherein a diameter of the three coils in the top portion is one millimeter (mm) as seen from a cross-sectional view of a coil, and a height of the three coils is 3.0 mm as seen from the side-view.

6. The coil spring of claim 1, wherein one of the three coils from the top portion resides in the flat plane as seen from the bottom-view of the bottom portion when the bottom portion is in the compressed state.

7. The coil spring of claim 1, wherein an effective resistance of the coil spring decreases when the coil spring is compressed from an uncompressed state to the compressed state.

8. A conical compression spring made by winding a conductive wire, comprising:
a top portion having at least two coils forming two circles with equal diameters in which the two coils are vertically stacked such that a circumference of a bottom surface of one coil engages a circumference of a top surface of another coil, having a shape of a straight cylinder as seen from a side-view of the top portion, and having a top coil that extends more than one turn in a spiral shape in which an entirety of the more than one turn resides in a horizontal plane as seen from a top-view of the top portion; and
a bottom portion having a shape of a truncated-cone in an uncompressed state as seen from the side-view, having a diameter larger than the top portion, having less than two turns, and collapsing into a horizontal plane when the bottom portion is compressed to a collapsed state.

9. The conical compression spring of claim 8, wherein the top coil winds along the horizontal plane as seen from the top-view of the top portion for at least 500 degrees.

10. The conical compression spring of claim 8, wherein the top portion is inelastic and includes three stacked coils that are concentric and contact each other such that a height of the top portion remains unchanged when the conical compression spring is fully compressed.

11. The conical compression spring of claim 8, wherein a height of the top portion is at least 2.0 mm from the side-view.

12. The conical compression spring of claim 8, wherein the bottom portion is elastic with a free height being at least two times greater than a height of the bottom portion when the bottom portion is compressed to the collapsed state.

13. The conical compression spring of claim 8, wherein the conical compression spring has a height in the uncompressed state as seen from the side-view of at least 5.0 millimeters (mm), and the height decreases from the uncompressed state to the collapsed state.

14. The conical compression spring of claim 8, wherein a height of the bottom portion as seen from the side-view is at least 2.7 mm in the uncompressed state, and the height of the bottom portion decreases when the conical compression spring is compressed to the collapsed state.

15. A coil spring, comprising:
a bottom portion having a base coil that resides in a flat surface, having an active portion that extends less than one turn from the base coil, having a shape of a truncated-cone in an uncompressed state as seen from a side-view of the bottom portion, and collapsing into the flat surface when the bottom portion is compressed to a collapsed state; and
an top portion having a diameter smaller than the bottom portion, having three coils that are vertically stacked on top of each other to have a straight cylindrical shape in a side-view of the top portion and that are connected together such that no gap exists between the three coils in the side-view, and having a top coil that extends more than one turn in a spiral shape in which an entirety of the more than one turn resides in a flat plane as seen from a top-view of the coil spring.

16. The coil spring of claim 15, wherein the top coil winds along the flat plane as seen from the top-view of the coil spring for at least 360 degrees.

17. The coil spring of claim 15, wherein the top portion includes three concentric coils vertically in contact with each other such that a height of the top portion remains at 3 millimeters when the coil spring is fully compressed.

18. The coil spring of claim 15, wherein the active portion is elastic and extends less than one turn from the base coil to the top portion and has a free height of at least two times greater than a height of the bottom portion when the coil spring is compressed to the collapsed state.

19. The coil spring of claim 15, wherein the active portion and the base coil reside in the flat surface to form a spiral shape on the flat plane with one and one-half turns as seen from a bottom view of the coil spring when the coil spring is compressed to the collapsed state.

20. The coil spring of claim 15, wherein an effective resistance of the coil spring reduces by at least 8 percent when the coil spring is compressed from the uncompressed state to the collapsed state.
